(19) United States
(12) Patent Application Publication
(10) Pub. No.: US 2025/0334292 A1
(43) Pub. Date: Oct. 30, 2025

(54) AIR CONDITIONER AND CONTROL METHOD THEREOF

(71) Applicant: Samsung Electronics Co., Ltd., Suwon-si (KR)

(72) Inventors: Daechul HAN, Suwon-si (KR); Manki HA, Suwon-si (KR); Youngjin KIM, Suwon-si (KR); Sangwoo LEE, Suwon-si (KR); Sukho LEE, Suwon-si (KR); Ilyong CHO, Suwon-si (KR); Hyeongkyu CHO, Suwon-si (KR); Kwangsik HAN, Suwon-si (KR); Jun HWANG, Suwon-si (KR)

(21) Appl. No.: 19/264,787

(22) Filed: Jul. 9, 2025

Related U.S. Application Data
(63) Continuation of application No. PCT/KR2023/019421, filed on Nov. 29, 2023.

(30) Foreign Application Priority Data
Jan. 19, 2023 (KR) 10-2023-0008326
Mar. 3, 2023 (KR) 10-2023-0028604

(51) Int. Cl. F24F 11/63

(52) U.S. Cl. CPC F24F 11/63

(57) ABSTRACT

An air conditioner, includes: an indoor controller receiving an operation command and to generate a plurality of first signals corresponding to the operation command; a main controller connected to the indoor controller, receives the plurality of first signals, and combines the plurality of first signals to convert the first signals into a single second signal; an outdoor unit connected to the main controller, operating based on the single second communication signal received from the main controller, and generates a third signal corresponding to the operation state of the outdoor unit; and an indoor unit connected to the main controller and having an indoor unit fan, wherein the main controller determines the type of the indoor controller based on the plurality of first signals, and controls the operation of the indoor unit based on the type of the indoor controller and a temperature setting signal among the plurality of first signals.

### CROSS-REFERENCE TO RELATED APPLICATIONS

This application is a continuation of International Application No. PCT/KR2023/019421 designating the United States, filed on Nov. 29, 2023, in the Korean Intellectual Property Receiving Office and claiming priority to Korean Patent Application Nos. 10-2023-0008326, filed on Jan. 19, 2023, and 10-2023-0028604, filed on Mar. 3, 2023, in the Korean Intellectual Property Office, the disclosures of each of which are incorporated by reference herein in their entireties.

### BACKGROUND

### Field

The present disclosure relates to an air conditioner and a control method thereof.

### Description of Related Art

An air conditioner may refer to a device that cools or heats air using heat transfer generated from evaporation and condensation of a refrigerant, and conditions indoor air by discharging the cooled or heated air into an indoor space. The air conditioner may cool or heat the indoor space by circulating the refrigerant through a compressor, an indoor heat exchanger, and an outdoor heat exchanger during cooling operation or heating operation, and by discharging air, which has undergone heat exchange at the indoor heat exchanger, into the indoor space.

The air conditioner may include an indoor controller that generates a contact signal, and may control cooling and heating according to the contact signal input through the indoor controller. However, an external input device such as a conventional indoor controller has a limitation in being compatible with an outdoor unit with improved energy efficiency.

In addition, because the outdoor unit and the indoor unit are connected to the indoor controller through a contact, there has been a problem in that separate function control such as room temperature control is not possible.

### SUMMARY

Embodiments of the disclosure provide an air conditioner and a control method of the air conditioner, which may replace an outdoor unit with an inverter outdoor unit with improved energy efficiency without replacing an indoor controller and an indoor unit, and may perform room temperature control based on a state of the outdoor unit and the indoor unit.

An air conditioner according to an example embodiment includes: an indoor controller, comprising circuitry, configured to receive, as input, an operation command and to generate a plurality of first signals corresponding to the operation command; a main controller, comprising circuitry, connected to the indoor controller, configured to receive the plurality of first signals and to combine and convert the plurality of first signals into a single second signal; an outdoor unit connected to the main controller, configured to operate based on the single second communication signal received from the main controller, and to generate a third signal corresponding to an operating state of the outdoor unit; and an indoor unit, connected to the main controller, in which a fan of the indoor unit is provided, in which the main controller is configured to determine a type of the indoor controller based on the plurality of first signals, and to control an operation of the indoor unit based on the type of the indoor controller and a temperature setting signal among the plurality of first signals.

A method of controlling an air conditioner according to an example embodiment includes: receiving, by an indoor controller, as input, an operation command and generating a plurality of first signals corresponding to the operation command; receiving, by a main controller connected to the indoor controller, the plurality of first signals, combining the plurality of first signals, and converting the combined signals into a single second signal; generating, by an outdoor unit connected to the main controller and operating based on the single second communication signal received from the main controller, a third signal corresponding to an operation state of the outdoor unit; and determining, by the main controller, a type of the indoor controller based on the plurality of first signals, and controlling an operation of the indoor unit based on the type of the indoor controller and a temperature setting signal among the plurality of first signals.

According to various example embodiments of the present disclosure, it is possible to implement communication between the outdoor unit and the main controller, so that on/off signals of the indoor controller and information of the outdoor unit may be integrated, and accordingly, there is an effect that it is possible to implement more stable room temperature control. In addition, as the outdoor unit actively intervenes in the target pressure adjustment and wind volume level control of the indoor unit when approaching the target set temperature, the frequency of the on/off signal of the indoor controller may be reduced and the fluctuation range of the room temperature may be minimized or reduced, thereby achieving the effect of improving energy efficiency.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example configuration of an air conditioner according to various embodiments;

FIG. 2 is a block diagram illustrating an example configuration of an air conditioner according to various embodiments;

FIG. 3 is a diagram illustrating a main controller according to various embodiments;

FIG. 4 is a diagram illustrating a connection between the main controller and other components in the air conditioner according to various embodiments;

FIG. 5 is a graph illustrating a process in which cooling is controlled by the main controller when the indoor controller is a 2-stage indoor controller according to various embodiments;

FIG. 6 is a graph illustrating a process in which heating is controlled by the main controller when the indoor controller is a 2-stage indoor controller according to various embodiments;

FIG. 7 is a graph illustrating a process in which cooling is controlled by the main controller when the indoor controller is a 1-stage indoor controller according to various embodiments;

FIG. 8 is a graph illustrating a process in which heating is controlled by the main controller when the indoor controller is a 1-stage indoor controller according to various embodiments;

FIG. 9 is a flowchart illustrating an example method of controlling an air conditioner according to various embodiments; and

FIG. 10 is a flowchart illustrating the example method of controlling the air conditioner following FIG. 9 according to various embodiments.

### DETAILED DESCRIPTION

Various example embodiments of the disclosure and the terms used in the various embodiments are not intended to limit the technical features disclosed in this disclosure to particular embodiments and should be understood as including various alterations, equivalents, or alternatives of the corresponding embodiments.

In connection with the description of the drawings, the similar reference numerals may be used for the similar or relevant elements.

The singular form of a noun corresponding to an item may include one or plurality of the items, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

The term “and/or” includes a combination of a plurality of related elements or any element among the plurality of related constituent elements.

Such terms as “1st” and “2nd,” or “first” and “second” may be used to simply distinguish a corresponding element from another, and does not limit the elements in other aspect (e.g., importance or order).

When a element (e.g., a first element) is referred to, with or without the term “operatively” or “communicatively,” as “coupled with,” “coupled to,” “connected with,” or “connected to” another element (e.g., a second element), the element may be coupled with the other element directly (e.g., wiredly), wirelessly, or via a third element.

It should be understood the terms “comprises,” “comprising,” “includes,” “including,” “containing,” “has,” “having” or other variations thereof are inclusive and therefore specify the presence of stated features, integers, steps, operations, elements, components, or combinations thereof disclosed in this disclosure, but do not preclude the presence or addition of one or more other features, integers, steps, operations, elements, components, or combinations thereof.

When an element is said to be “connected,” “coupled,” “supported,” or “in contact” with another element, this includes not only cases where the elements are directly connected, coupled, supported, or in contact with each other, but also cases where they are indirectly connected, coupled, supported, or in contact through a third element.

When an element is said to be positioned “on” another element, this includes not only cases where the element is in direct contact with the other element, but also cases where another element exists between the two elements.

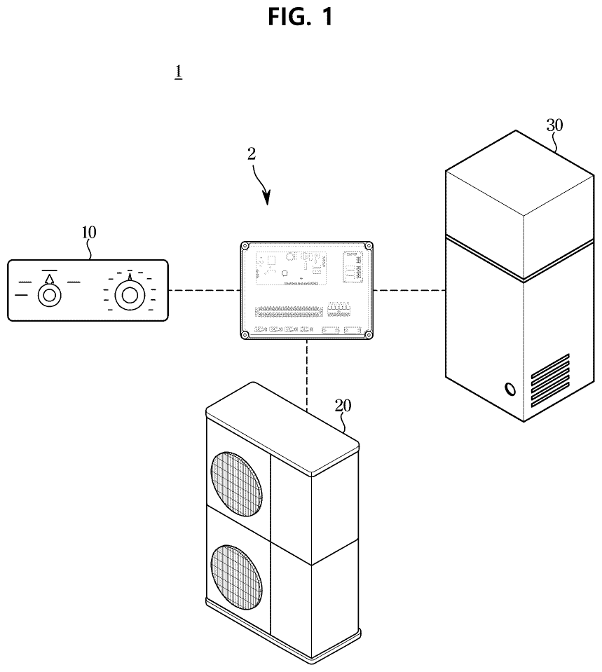

Referring to FIG. 1, an air conditioner 1 according to various embodiments may refer, for example, to a device that performs functions such as air purification, ventilation, humidity control, cooling, or heating in an air-conditioned space (hereinafter referred to as “indoor”), and refers to a device having at least one of such functions.

According to an embodiment, the air conditioner 1 may include a heat pump device to perform a cooling function or a heating function. The heat pump device may include a refrigeration cycle in which a refrigerant circulates along a compressor, a first heat exchanger, an expansion device, and a second heat exchanger. All components of the heat pump device may be embedded in one housing forming the exterior of the air conditioner 1, and a window-type air conditioner or a portable air conditioner corresponds to such an air conditioner 1. On the other hand, in a plurality of housings forming one air conditioner 1, some components of the heat pump device may be separately embedded, and a wall-mounted air conditioner, a stand-type air conditioner, a system air conditioner or the like may be included therein.

The air conditioner 1 including the plurality of housings may include at least one outdoor unit 20 installed outdoors and at least one indoor unit 30 installed indoors. For example, the air conditioner 1 may be provided such that one outdoor unit 20 is connected to one indoor unit 30 through a refrigerant pipe. For example, the air conditioner 1 may be provided such that one outdoor unit 20 is connected to two or more indoor units 30 through a refrigerant pipe. For example, the air conditioner 1 may be provided such that two or more outdoor units 20 are connected to two or more indoor units 30 through a plurality of refrigerant pipes.

The outdoor unit 20 may be electrically connected to the indoor unit 30. For example, information (or a command) for controlling the air conditioner 1 may be input through an input interface provided to the outdoor unit 20 or the indoor unit 30, and in response to user input, the outdoor unit 20 and the indoor unit 30 may operate simultaneously or sequentially.

The air conditioner 1 may include an outdoor heat exchanger provided to the outdoor unit 20, an indoor heat exchanger provided to the indoor unit 30, and a refrigerant pipe connecting the outdoor heat exchanger and the indoor heat exchanger.

The outdoor heat exchanger may perform heat exchange between the refrigerant and outdoor air using a phase change of the refrigerant (for example, evaporation or condensation). For example, while the refrigerant is condensed in the outdoor heat exchanger, the refrigerant may release heat to the outdoor air, and while the refrigerant flowing through the outdoor heat exchanger is evaporated, the refrigerant may absorb heat from the outdoor air.

The indoor unit 30 is provided indoors. For example, the indoor unit 30 may be classified as a ceiling-type indoor unit 30, a stand-type indoor unit 30, or a wall-mounted indoor unit 30, according to the disposition method. For example, the ceiling-type indoor unit 30 may be classified as a 4-way indoor unit 30, a 1-way indoor unit 30, or a duct-type indoor unit 30, according to the air discharge method.

Similarly, the indoor heat exchanger may perform heat exchange between the refrigerant and indoor air using a phase change of the refrigerant (for example, evaporation or condensation). For example, while the refrigerant is evaporated in the indoor unit 30, the refrigerant may absorb heat from indoor air, and by blowing the indoor air cooled through the cooled indoor heat exchanger, the room may be cooled. In addition, while the refrigerant is condensed in the indoor heat exchanger, the refrigerant may release heat to the indoor air, and by blowing the indoor air heated through the high-temperature indoor heat exchanger, the room may be heated.

For example, the air conditioner 1 performs a cooling or heating function through the phase change process of the refrigerant circulating between the outdoor heat exchanger and the indoor heat exchanger, and to circulate the refrigerant, the air conditioner 1 may include a compressor that compresses the refrigerant. The compressor may suck (e.g., take in) refrigerant gas through a suction portion and compress the refrigerant gas. The compressor may discharge high-temperature and high-pressure refrigerant gas through a discharge portion. The compressor may be disposed inside the outdoor unit 20.

The refrigerant may circulate in the order of the compressor, outdoor heat exchanger, expansion device, and indoor heat exchanger through a refrigerant pipe, or in the order of the compressor, indoor heat exchanger, expansion device, and outdoor heat exchanger.

For example, when the air conditioner 1 includes one outdoor unit 20 and one indoor unit 30 directly connected through a refrigerant pipe, the refrigerant may be provided to circulate between the one outdoor unit 20 and the one indoor unit 30 through the refrigerant pipe.

For example, when the air conditioner 1 includes one outdoor unit 20 connected to two or more indoor units 30 through a refrigerant pipe, the refrigerant may flow to the plurality of indoor units 30 through the refrigerant pipe branched from the outdoor unit 20. The refrigerant discharged from the plurality of indoor units 30 may be merged and provided to circulate to the outdoor unit 20. For example, the plurality of indoor units 30 may be connected in parallel to one outdoor unit 20 through respective individual refrigerant pipes.

The plurality of indoor units 30 may each be operated independently according to operation modes set by the user. For example, among the plurality of indoor units 30, some may operate in a cooling mode, while others may operate in a heating mode simultaneously. In this case, the refrigerant may be selectively introduced into and discharged from each indoor unit 30 in a high-pressure or low-pressure state along a designated circulation path via a flow path switching valve to be described below, and may be provided to circulate to the outdoor unit 20.

For example, when the air conditioner 1 includes two or more outdoor units 20 and two or more indoor units 30 connected through a plurality of refrigerant pipes, the refrigerant discharged from the plurality of outdoor units 20 may be merged and flow through one refrigerant pipe, and then be branched again at a certain point to be introduced into the plurality of indoor units 30.

The plurality of outdoor units 20 may all be driven or at least some may not be driven depending on the operation load according to the operation amount of the plurality of indoor units 30. In this case, the refrigerant may be provided to be introduced and circulated through the outdoor unit 20 that is selectively driven via the flow path switching valve. The air conditioner 1 may include an expansion device to lower the pressure of the refrigerant introduced into the heat exchanger. For example, the expansion device may be disposed inside the indoor unit 30 or inside the outdoor unit 20, or may be disposed in both.

The expansion device may, for example, lower the temperature and pressure of the refrigerant using a throttling effect. The expansion device may include an orifice that may reduce the cross-sectional area of the flow path. The refrigerant passing through the orifice may have reduced temperature and pressure.

The expansion device may, for example, be implemented as an electronic expansion valve capable of adjusting an opening ratio (the ratio of the cross-sectional area of the valve flow path in a partially open state to the cross-sectional area of the valve flow path in a fully open state). The amount of refrigerant passing through the expansion device may be controlled depending on the opening ratio of the electronic expansion valve.

The air conditioner 1 may further include a flow path switching valve disposed on the refrigerant circulation flow path. The flow path switching valve may include, for example, a 4-way valve. The flow path switching valve may determine the circulation path of the refrigerant depending on the operation mode (for example, cooling operation or heating operation) of the indoor unit 30. The flow path switching valve may be connected to the discharge portion of the compressor.

The air conditioner 1 may include an accumulator. The accumulator may be connected to the suction portion of the compressor. A low-temperature, low-pressure refrigerant evaporated in the indoor heat exchanger or the outdoor heat exchanger may be introduced into the accumulator.

When a refrigerant in which refrigerant liquid and refrigerant gas are mixed is introduced, the accumulator may separate the refrigerant liquid from the refrigerant gas and provide the refrigerant gas, from which the refrigerant liquid has been separated, to the compressor.

An outdoor fan may be provided near the outdoor heat exchanger. The outdoor fan may blow outdoor air to the outdoor heat exchanger to promote heat exchange between the refrigerant and the outdoor air.

The outdoor unit 20 of the air conditioner 1 may include at least one sensor. For example, the sensor of the outdoor unit 20 may be provided as an environmental sensor. The sensor of the outdoor unit 20 may be disposed at any position inside or outside the outdoor unit 20. For example, the sensor of the outdoor unit 20 may include a temperature sensor for detecting the air temperature around the outdoor unit 20, a humidity sensor for detecting the air humidity around the outdoor unit 20, a refrigerant temperature sensor for detecting the refrigerant temperature of a refrigerant pipe passing through the outdoor unit 20, or a refrigerant pressure sensor for detecting the refrigerant pressure of a refrigerant pipe passing through the outdoor unit 20.

The outdoor unit 20 of the air conditioner 1 may include a communication circuitry 100 of the outdoor unit 20. The communication circuitry 100 of the outdoor unit 20 may be provided to receive a control signal from a controller 110 of the indoor unit 30 of the air conditioner 1, which will be described below. The outdoor unit 20 may control the operation of the compressor, outdoor heat exchanger, expansion device, flow path switching valve, accumulator, or outdoor fan based on the control signal received through the communication circuitry 100 of the outdoor unit 20. The outdoor unit 20 may transmit sensing values detected from the sensor of the outdoor unit 20 to the controller 110 of the indoor unit 30 through the communication circuitry 100 of the outdoor unit 20.

The indoor unit 30 of the air conditioner 1 may include a housing, a blower that circulates air inside or outside the housing, and an indoor heat exchanger that performs heat exchange with air introduced into the interior of the housing.

The housing may include an intake port. Indoor air may be introduced into the interior of the housing through the intake port.

The indoor unit 30 of the air conditioner 1 may include a filter provided to filter foreign substances from the air introduced into the housing through the intake port.

The housing may include a discharge port. Air flowing inside the housing may be discharged to the outside of the housing through the discharge port.

The housing of the indoor unit 30 may be provided with an airflow guide that guides the direction of the air discharged through the discharge port. For example, the airflow guide may include a blade positioned on the discharge port. For example, the airflow guide may include an auxiliary fan for adjusting the discharge airflow. The present disclosure is not limited thereto and the airflow guide may be omitted.

An indoor heat exchanger and a blower may be provided inside the housing of the indoor unit 30, and may be disposed on a flow path connecting the intake port and the discharge port.

The blower may include an indoor fan and a fan motor. For example, the indoor fan may include an axial fan, a diagonal fan, a cross-flow fan, or a centrifugal fan.

The indoor heat exchanger may be disposed between the blower and the discharge port, or may be disposed between the intake port and the blower. The indoor heat exchanger may absorb heat from air introduced through the intake port, or may transfer heat to air introduced through the intake port. The indoor heat exchanger may include a heat exchange tube through which a refrigerant flows internally, and a heat exchange fin in contact with the heat exchange tube to increase the heat transfer area.

The indoor unit 30 of the air conditioner 1 may include a drain tray disposed under the indoor heat exchanger to collect condensate generated by the indoor heat exchanger. The condensate collected in the drain tray may be drained to the outside through a drainage hose. The drain tray may be provided to support the indoor heat exchanger.

The indoor unit 30 of the air conditioner 1 may include an input interface. The input interface may include any type of user input means, including buttons, switches, a touch screen, and/or a touch pad. A user may directly input setting data (e.g., a desired indoor temperature, an operation mode setting for cooling/heating/dehumidification/air purification, an outlet port selection setting, and/or a wind volume level setting) through the input interface.

The input interface may also be connected to an external input device. For example, the input interface may be electrically connected to a wired remote controller. The wired remote controller may be installed at a specific location in the indoor space (e.g., a portion of the wall). The user may manipulate the wired remote controller to input setting data related to the operation of the air conditioner 1. An electrical signal corresponding to the setting data acquired through the wired remote controller may be transmitted to the input interface. In addition, the input interface may include an infrared sensor. The user may input setting data related to an operation of the air conditioner 1 remotely using a wireless remote controller. The setting data input through the wireless remote controller may be transmitted to the input interface as an infrared signal.

The input interface may include a microphone. A voice command of the user may be acquired through the microphone. The microphone may convert the voice command of the user into an electrical signal, and may transmit the converted electrical signal to the controller 110 of the indoor unit 30. The controller 110 of the indoor unit 30 may control components of the air conditioner 1 in order to execute a function corresponding to the voice command of the user. The setting data (e.g., a desired indoor temperature, an operation mode setting for cooling/heating/dehumidification/air purification, an outlet port selection setting, and/or a wind volume level setting) acquired through the input interface may be transmitted to the controller 110 of the indoor unit 30 to be described below. For example, the setting data acquired through the input interface may be transmitted to the outside, that is, to the outdoor unit 20 or to a server, through the communication circuitry 100 of the indoor unit 30 to be described below.

The indoor unit 30 of the air conditioner 1 may include a power module. The power module may be connected to an external power source to supply power to components of the indoor unit 30.

The indoor unit 30 of the air conditioner 1 may include a sensor of the indoor unit 30. The sensor of the indoor unit 30 may be an environmental sensor disposed in a space inside or outside the housing. For example, the sensor of the indoor unit 30 may include one or more temperature sensors and/or humidity sensors disposed in a predetermined space inside or outside the housing of the indoor unit 30. For example, the sensor of the indoor unit 30 may include a refrigerant temperature sensor for detecting a temperature of refrigerant in a refrigerant pipe passing through the indoor unit 30. For example, the sensor of the indoor unit 30 may include respective refrigerant temperature sensors for detecting inlet, middle, and/or outlet temperatures of the refrigerant pipe passing through the indoor heat exchanger.

For example, each environmental information detected by the sensor of the indoor unit 30 may be transmitted to the controller 110 of the indoor unit 30 be described below, or may be transmitted to the outside through the communication circuitry 100 of indoor unit 30 to be described below.

The indoor unit 30 of the air conditioner 1 may include the communication circuitry 100 of the indoor unit 30. The communication circuitry 100 of the indoor unit 30 may include at least one of a short-range wireless communication module or a long-range wireless communication module. The communication circuitry 100 of the indoor unit 30 may include at least one antenna for wirelessly communicating with another device. The outdoor unit 20 may include the communication circuitry 100 of the outdoor unit 20. The communication circuitry 100 of the outdoor unit 20 may also include at least one of a short-range wireless communication module or a long-range wireless communication module.

The short-range wireless communication module may include a Bluetooth communication module, a Bluetooth low energy (BLE) communication module, a near field communication module, a WLAN (Wi-Fi) communication module, a Zigbee communication module, an infrared Data Association (IrDA) communication module, a Wi-Fi Direct (WFD) communication module, a ultrawideband (UWB) communication module, an Ant+communication module, a microwave (uWave) communication module, and the like, but is not limited thereto.

The long-range wireless communication module may include a communication module for performing various types of long-range communication and may include a mobile communication circuitry 100. The mobile communication circuitry 100 transmits and receives wireless signals with at least one of a base station, an external terminal, or a server on a mobile communication network.

The communication circuitry 100 of the indoor unit 30 may communicate with external devices such as a server, a mobile device, or another home appliance through an access point (AP) in the vicinity. The access point (AP) may connect a local area network (LAN), to which the air conditioner 1 or the user device is connected, to a wide area network (WAN) to which the server is connected. The air conditioner 1 or the user device may be connected to the server through the wide area network (WAN). The indoor unit 30 of the air conditioner 1 may include the controller 110 of the indoor unit 30 that controls the components of the indoor unit 30, including a blower, etc. The outdoor unit 20 of the air conditioner 1 may include the controller 110 of the outdoor unit 20 that controls the components of the outdoor unit 20, including a compressor, etc. The controller 110 of the indoor unit 30 may communicate with the controller 110 of the outdoor unit 20 through the communication circuitry 100 of the indoor unit 30 and the communication circuitry 100 of the outdoor unit 20. The communication circuitry 100 of the outdoor unit 20 may transmit a control signal generated by the controller 110 of the outdoor unit 20 to the communication circuitry 100 of the indoor unit 30, or may transmit a control signal transmitted from the communication circuitry 100 of the indoor unit 30 to the controller 110 of the outdoor unit 20. That is, the outdoor unit 20 and the indoor unit 30 may perform bidirectional communication. The outdoor unit 20 and the indoor unit 30 may transmit and receive various signals generated during the operation of the air conditioner 1.

The controller 110 of the outdoor unit 20 may be electrically connected to the components of the outdoor unit 20 and may control operations of the respective components. For example, the controller 110 of the outdoor unit 20 may adjust a frequency of the compressor, and may control a flow path switching valve such that a circulation direction of the refrigerant is switched. The controller 110 of the outdoor unit 20 may adjust a rotation speed of the outdoor fan. In addition, the controller 110 of the outdoor unit 20 may generate a control signal for adjusting an opening degree of the expansion valve. Under control of the controller 110 of the outdoor unit 20, the refrigerant may circulate along a refrigerant circulation circuit including the compressor, the flow path switching valve, the outdoor heat exchanger, the expansion valve, and the indoor heat exchanger.

Various temperature sensors included in the outdoor unit 20 and the indoor unit 30 may each transmit electrical signals corresponding to the detected temperatures to the controller 110 of the outdoor unit 20 and/or the controller 110 of the indoor unit 30. For example, humidity sensors included in the outdoor unit 20 and the indoor unit 30 may each transmit electrical signals corresponding to the detected humidity to the controller 110 of the outdoor unit 20 and/or the controller 110 of the indoor unit 30.

The controller 110 of the indoor unit 30 may acquire user input from a user device including a mobile device, etc. through the communication circuitry 100 of the indoor unit 30, and may acquire the user input directly through an input interface or through a remote controller. The controller 110 of the indoor unit 30 may control the components of the indoor unit 30 including a blower, etc. in response to the received user input. The controller 110 of the indoor unit 30 may transmit information on the received user input to the controller 110 of the outdoor unit 20.

The controller 110 of the outdoor unit 20 may control the components of the outdoor unit 20 including a compressor, etc. based on the information on the user input received from the indoor unit 30. For example, when a control signal corresponding to a user input for selecting an operation mode such as a cooling operation, a heating operation, a blowing operation, a defrosting operation, or a dehumidifying operation is received from the indoor unit 30, the controller 110 of the outdoor unit 20 may control the components of the outdoor unit 20 so that an operation of the air conditioner 1 corresponding to the selected operation mode is performed.

The controller 110 of the outdoor unit 20 and the controller 110 of the indoor unit 30 may each include a processor 111 and a memory 112. The controller 110 of the indoor unit 30 may include at least one first processor 111 and at least one first memory 112, and the controller 110 of the outdoor unit 20 may include at least one second processor 111 and at least one second memory 112.

The memory 112 may memorize/store various information required for the operation of the air conditioner 1. The memory 112 may store instructions, applications, data, and/or programs required for the operation of the air conditioner 1. For example, the memory 112 may store various programs for cooling operation, heating operation, dehumidifying operation, and/or defrosting operation of the air conditioner 1. The memory 112 may include volatile memory 112 such as static random access memory (S-RAM) or dynamic random access memory (D-RAM) for temporarily storing data. In addition, the memory 112 may include non-volatile memory 112 such as read-only memory (ROM), erasable programmable read-only memory (EPROM), or electrically erasable programmable read-only memory (EEPROM) for long-term data storage.

The processor 111 may include various processing circuitry and generate a control signal for controlling the operation of the air conditioner 1 based on the instructions, applications, data, and/or programs stored in the memory 112. The processor 111, as hardware, may include a logic circuit and an arithmetic circuit. The processor 111 may process data according to the program and/or instruction provided from the memory 112 and may generate a control signal according to the processing result. The memory 112 and the processor 111 may be implemented as one control circuit or as a plurality of circuits. Thus, the processor 111 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The indoor unit 30 of the air conditioner 1 may include an output interface. The output interface may be electrically connected to the controller 110 of the indoor unit 30 and may output information related to the operation of the air conditioner 1 under the control of the controller 110 of the indoor unit 30. For example, information such as the operation mode selected by user input, wind direction, wind volume level, and temperature may be output. In addition, the output interface may output sensing information acquired from the sensor of the indoor unit 30 or the sensor of the outdoor unit 20, and warning/error messages.

The output interface may include a display and a speaker. The speaker, as a sound device, may output various sounds. The display may display information input by the user or information provided to the user as various graphic elements. For example, operation information of the air conditioner 1 may be displayed as at least one of an image or text. In addition, the display may include an indicator that provides specific information. The display may include a liquid crystal display panel (LCD panel), a light emitting diode panel (LED panel), an organic light emitting diode panel (OLED panel), a micro LED panel, and/or a plurality of LEDs.

Hereinafter, various example embodiments according to the present disclosure will be described in greater detail with reference to the accompanying drawings.

FIG. 1 is a diagram illustrating an example configuration of an air conditioner according to various embodiments.

With reference to FIG. 1, the air conditioner 1 includes the outdoor unit 20, which is provided in an outdoor space and performs heat exchange between outdoor air and a refrigerant, and the indoor unit 30, which is provided in an indoor space and performs heat exchange between indoor air and the refrigerant. The outdoor unit 20 may be located outside the air-conditioned space, and the indoor unit 30 may be located inside the air-conditioned space. The air-conditioned space refers to a space that is cooled or heated by the air conditioner 1. For example, the outdoor unit 20 may be disposed outside a building, and the indoor unit 30 may be disposed in a space separated from the outside by a wall, such as a living room or an office.

As described above, the outdoor unit 20 and the indoor unit 30 may be connected through an external pipe. The refrigerant may circulate through the outdoor unit 20, the external pipe, and the indoor unit 30. One end of the external pipe may be connected to a pipe valve provided on one side of the outdoor unit 20. In addition, the external pipe may be connected to a refrigerant pipe provided inside the outdoor unit 20 and the indoor unit 30.

The refrigerant may circulate through the indoor unit 30 and the outdoor unit 20 along the refrigerant flow path, and may absorb or release heat through a phase change (e.g., a phase change from gas to liquid, or a phase change from liquid to gas). The air conditioner 1 may include a liquid pipe that connects the outdoor unit 20 and the indoor unit 30 and serves as a passage through which liquid-phase refrigerant flows, and a gas pipe that serves as a passage through which gas-phase refrigerant flows. The liquid pipe and the gas pipe may extend into the outdoor unit 20 and the indoor unit 30.

The outdoor unit 20 may include a compressor that compresses the refrigerant, an outdoor heat exchanger that performs heat exchange between outdoor air and the refrigerant, a 4-way valve that guides the refrigerant compressed by the compressor to the outdoor heat exchanger or the indoor heat exchanger based on cooling operation or heating operation, an expansion valve that reduces the pressure of the refrigerant, and an accumulator that prevents or reduces liquid-phase refrigerant that has not evaporated from being introduced into the compressor.

The compressor may operate by being supplied with electrical energy from an external power source. The compressor includes a compressor motor and compresses low-pressure gas-phase refrigerant into high pressure using the rotational force of the compressor motor. The compressor may change its operating frequency to correspond to the capacity required by the indoor unit 30. The compressor may be an inverter air compressor, a positive displacement compressor, or a dynamic compressor, and various types of compressors that may be considered by a designer may be used.

The indoor unit 30 may include an indoor heat exchanger and an indoor fan. The indoor heat exchanger performs heat exchange between indoor air and refrigerant. The indoor fan may cause indoor air to flow through the indoor heat exchanger. The indoor fan may be provided in plurality. Indoor heat exchanger temperature sensors for detecting the temperature of the indoor heat exchanger may be provided on both sides (inlet and outlet) of the indoor heat exchanger. The indoor heat exchanger temperature sensor may be installed near the inlet and/or the outlet of the indoor heat exchanger, or may be installed to be in contact with the refrigerant pipe connected to the inlet and/or the outlet of the indoor heat exchanger. An indoor temperature sensor for detecting the indoor temperature may be provided inside the indoor unit 30. The temperature sensor may be implemented as at least one of a bimetal thermometer, a thermistor thermometer, or an infrared thermometer. In addition, the air conditioner 1 may include various temperature sensors.

During cooling operation, the refrigerant may release heat at the outdoor heat exchanger of the outdoor unit 20 and may absorb heat at the indoor heat exchanger of the indoor unit 30. During cooling operation, the refrigerant compressed by the compressor of the outdoor unit 20 may be supplied first to the outdoor heat exchanger via the 4-way valve and may be supplied to the indoor heat exchanger of the indoor unit 30 via the expansion valve. During cooling operation, the outdoor heat exchanger operates as a condenser that condenses the refrigerant, and the indoor heat exchanger operates as an evaporator that evaporates the refrigerant. During cooling operation, the high-temperature high-pressure gas-phase refrigerant discharged from the compressor moves to the outdoor heat exchanger. The refrigerant condensed at the outdoor heat exchanger in liquid phase or near liquid phase is expanded and pressure-reduced at the expansion valve. The two-phase refrigerant that has passed through the expansion valve moves to the indoor heat exchanger. The refrigerant introduced into the indoor heat exchanger is evaporated by exchanging heat with the surrounding air. Accordingly, the temperature of the heat-exchanged surrounding air decreases, and cold air is discharged to the outside of the indoor unit 30.

During heating operation, the refrigerant may release heat at the indoor heat exchanger and absorb heat at the outdoor heat exchanger. That is, during heating operation, the refrigerant compressed by the compressor may be supplied first to the indoor heat exchanger via the 4-way valve and then supplied to the outdoor heat exchanger. In this case, the indoor heat exchanger operates as a condenser that condenses the refrigerant, and the outdoor heat exchanger operates as an evaporator that evaporates the refrigerant. During heating operation, the high-temperature high-pressure gas-phase refrigerant discharged from the compressor moves to the indoor heat exchanger. The high-temperature high-pressure gas-phase refrigerant passing through the indoor heat exchanger exchanges heat with the low-temperature dry air. The refrigerant is condensed into a liquid or a refrigerant close to liquid while releasing heat, and warm air is discharged to the outside of the indoor unit 30 as the air absorbs the heat.

Although the air conditioner 1 has been described as including one outdoor unit 20 and one indoor unit 30, it may also include a plurality of outdoor units 20 and a plurality of indoor units 30. For example, a plurality of indoor units 30 may be connected to one outdoor unit 20. In addition, the form of the indoor unit 30 is not limited to the one described. As long as it is an indoor unit 30 that is installed in an indoor space and may cool or heat the indoor space, any form of indoor unit 30 may be applied.

In addition, the air conditioner 1 may include an indoor controller 10 and a main controller 2. The main controller 2 may be electrically connected to the outdoor unit 20, the indoor unit 30, and the indoor controller 10. The outdoor unit 20, the indoor unit 30, and the indoor controller 10 may be connected to the main controller 2 by wire. The indoor controller 10 may also be referred to as a “contact controller.”

The indoor controller 10 may acquire an input (e.g., a user input). The indoor controller 10 may acquire a user input regarding indoor temperature setting or cooling/heating. The main controller 2 may receive a plurality of first signals corresponding to the user input from the indoor controller 10.

The main controller 2 may control operations of the outdoor unit 20 and the indoor unit 30. The main controller 2 may operate the outdoor unit 20 and the indoor unit 30 in response to a user input that is input through the indoor controller 10. The main controller 2 may control an operation of the air conditioner 1 based on the received electrical signal.

The main controller 2 may perform a role of an adapter that connects various outdoor units 20 to the air conditioner 1. The main controller 2 is provided to be capable of controlling not only an outdoor unit 20 produced by a same manufacturer as that of the outdoor unit 20, but also an outdoor unit 20 produced by a different manufacturer and/or an outdoor unit 20 having a different communication protocol.

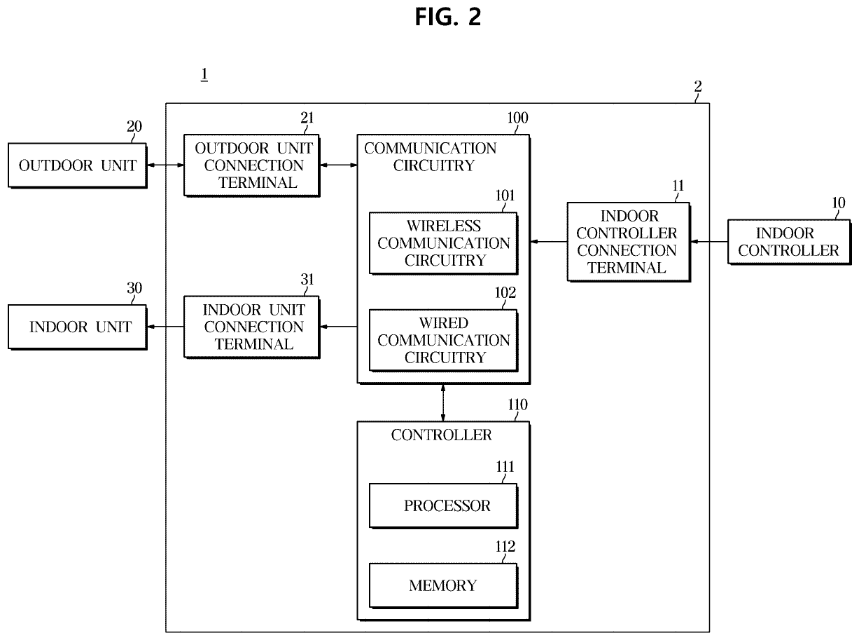

FIG. 2 is a block diagram illustrating an example configuration of an air conditioner according to various embodiments.

With reference to FIG. 2, the air conditioner 1 may include the main controller (e.g., including circuitry) 2, the indoor unit 30, the outdoor unit 20, and the indoor controller (e.g., including circuitry) 10, and the main controller 2 may include the controller 110 including the memory 112 and the processor (e.g., including processing circuitry) 111, and the communication circuitry 100.

The memory 112 of the main controller 2 may memorize/store various information necessary for an operation of the air conditioner 1. The memory 112 may store instructions, applications, data, and/or programs necessary for the operation of the air conditioner 1. As described above, the memory 112 may include a volatile memory 112 such as a static random access memory (S-RAM) and a dynamic random access memory (D-RAM), which temporarily stores data, and a non-volatile memory 112 such as a read only memory (ROM), an erasable programmable read only memory (EPROM), and an electrically erasable programmable read only memory (EEPROM), which stores data for a long time.

The processor 111 of the main controller 2 may include various processing circuitry and generate a control signal for controlling the operation of the air conditioner 1 based on the instructions, applications, data, and/or programs stored in the memory 112. The processor 111, as hardware, may include a logic circuit and an arithmetic circuit. The processor 111 may process data according to the program and/or instruction provided from the memory 112 and may generate a control signal according to the processing result. The memory 112 and the processor 111 may be implemented as one control circuit or as a plurality of circuits. Thus, the processor 111 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The main controller 2 may receive a plurality of first signals transmitted from the indoor controller 10 and may determine an operation of the outdoor unit 20 and/or the indoor unit 30. The first signal may include a contact signal generated from the contact controller, and the contact signal refers to a signal indicating whether a contact including a switch is in an open or closed state.

The controller 110 of the main controller 2 may include a signal conversion unit that combines the received plurality of first signals and converts them into a single second signal. In this case, the controller 110 may combine signals in an on state among the plurality of first signals and convert them into the second signal.

The second signal may include an RS 485 signal corresponding to the RS 485 communication standard, and may include a communication signal that follows a communication standard different from the first signal.

The controller 110 may transmit the second signal to the outdoor unit 20 to determine an operation of the outdoor unit 20, and the outdoor unit 20 may operate based on the second signal. Accordingly, the air conditioner 1 according to an embodiment may ensure compatibility even if the outdoor unit 20 that has been used is replaced with a different type of outdoor unit 20.

The controller 110 may perform bidirectional communication with the outdoor unit 20 through an outdoor unit connection terminal 21 including a transmission terminal and a reception terminal, and specifically, the controller 110 may control the communication circuitry 100 to transmit the second signal to the transmission terminal and to receive a third signal, which is an operation signal regarding the operation of the outdoor unit 20, from the reception terminal. Accordingly, the controller 110 may determine a current operation state of the outdoor unit 20 and a control operation required by the outdoor unit 20. For example, the controller 110 may determine whether to enter defrosting operation, whether to perform a cold air prevention/reduction function, and whether to perform a wind volume level control function based on the operation signal of the outdoor unit 20.

The controller 110 may determine an operation of the indoor unit 30 based on the plurality of first signals, and may control the communication circuitry 100 to transmit the determined operation of the indoor unit 30 to the indoor unit 30. For example, the controller 110 may determine an operation mode and a set temperature of the indoor unit 30 corresponding to the plurality of first signals.

The controller 110 may determine an operation of the indoor unit 30 by blocking transmission of at least one of the plurality of first signals for a reference time. For example, the controller 110 may control an indoor fan signal among the plurality of first signals to be blocked for a preset reference time to enable efficient defrosting operation. Accordingly, even if the indoor unit 30 is a different type of indoor unit 30 that is not an inverter indoor unit 30, the air conditioner fan, auxiliary heat source, and other air conditioning devices may be controlled by delaying or blocking some of the signals.

In this case, the operation of the indoor unit 30 may include selecting any one of a plurality of operation stages, and the plurality of operation stages may include low, medium, and high cooling/heating intensities.

In addition, the controller 110 may determine a type of the indoor controller 10 based on the plurality of first signals, and may control the operation of the indoor unit 30 based on the type of the indoor controller 10 and a temperature setting signal among the plurality of first signals. In this case, the type of the indoor controller 10 may include a 1-stage type and a 2-stage type, as will be described below.

In addition, the controller 110 of the main controller 2 may decrease the wind volume level of the indoor unit 30 from a third stage to a second stage according to a stage decrease command received from the indoor controller 10, based on the type of the indoor controller 10 being determined to be the 2-stage type.

In addition, the controller 110 may turn off the indoor unit 30 based on a target indoor temperature corresponding to the user's operation command being reached after the wind volume level of the indoor unit 30 is decreased from the third stage to the second stage, and may decrease the wind volume level of the indoor unit 30 from the second stage to the first stage based on the indoor unit 30 continuously operating at the second stage without turning off for a reference time after the wind volume level of the indoor unit 30 is decreased from the third stage to the second stage.

The controller 110 may increase a compressor pressure at the second stage based the wind volume level of the indoor unit 30 being changed from the second stage to the third stage within a reference time after the wind volume level of the indoor unit 30 is decreased from the third stage to the second stage.

The controller 110 may decrease the wind volume level of the indoor unit 30 from the third stage to the second stage according to a combination of the number of times the off signal is output and the off signal output time of the indoor controller 10, based on the type of the indoor controller 10 being determined to be the 1-stage type.

The controller 110 may turn off the indoor unit 30 based on the target indoor temperature corresponding to the user's operation command being reached after the wind volume level of the indoor unit 30 is decreased from the third stage to the second stage, and may decrease the wind volume level of the indoor unit 30 from the second stage to the first stage according to a combination of the number of times the off signal is output and the off signal output time of the indoor controller 10 after the wind volume level of the indoor unit 30 is decreased from the third stage to the second stage.

The controller 110 may increase the wind volume level of the indoor unit 30 from the second stage to the third stage based on the on duration and off duration of the indoor controller 10 after the wind volume level of the indoor unit 30 is decreased from the third stage to the second stage.

The communication circuitry 100 of the main controller 2 may include a circuit for electrically connecting the outdoor unit 20, the indoor unit 30, and the indoor controller 10. For example, the communication circuitry 100 may include a plurality of contact terminals connected to the indoor controller 10. The plurality of contact terminals may include the outdoor unit connection terminal 21 and the indoor unit connection terminal 31.

The communication circuitry 100 may include a wired communication circuitry 102 and/or a wireless communication circuitry 101 for performing communication with the outdoor unit 20 and the indoor unit 30. The communication circuitry 100 may transmit a control signal transmitted from the processor 111 to the outdoor unit 20 and the indoor unit 30, or may transmit an electrical signal transmitted from the outdoor unit 20 and the indoor unit 30 to the processor 111.

The communication circuitry 100 may perform communication with an access point (AP) (not illustrated) separately provided in the air-conditioned space and may be connected to a network through the access point. The communication circuitry 100 may perform communication with an external device (e.g., a smartphone) through the access point. The communication circuitry 100 may receive information of the external device connected to the access point and may transmit the information of the external device to the processor 111. Through this, the user may remotely control the air conditioner 1.

The air conditioner 1 according to an embodiment may further include a remote controller (not illustrated). The remote controller may include an input and a display. The input of the remote controller may acquire a user input and may output an electrical signal (voltage or current) corresponding to the user input to the main controller 2. For example, the remote controller may acquire a power on/off input for turning on or off the air conditioner 1, an operation mode selection input for setting an operation mode of the air conditioner 1, and/or a temperature adjustment input for adjusting the indoor temperature.

The input of the remote controller may be implemented with various buttons and/or dials. For example, the plurality of buttons may include a push switches and a membrane switch that are operated by being pressed by the user, and/or a touch switch that is operated by contact with a portion of the user's body. The buttons may include an operation mode button for selecting an operation mode such as cooling operation, heating operation, and blowing operation, a temperature button for setting a target temperature of the indoor space (air-conditioned space), a wind direction button for setting a direction of wind, and/or a wind volume level button for setting a strength of wind (rotation speed of an indoor fan). These buttons may also be implemented as a rotatable dial.

The display of the remote controller may display information related to a state and/or operation of the air conditioner 1. The display may display information input by the user or information provided to the user in various screens. The display may display information related to the operation of the air conditioner 1 as at least one of an image or text. In addition, the display may display a graphic user interface (GUI) that enables control of the air conditioner 1. That is, the display may display a user interface (UI) element such as an icon.

The display of the remote controller may include various types of display panels. For example, the display may include a liquid crystal display panel (LCD Panel), a light emitting diode panel (LED Panel), an organic light emitting diode panel (OLED Panel), or a micro LED panel. The display may be implemented as a touch display. The touch display may include a display panel for displaying images and a touch panel for receiving a touch input. When the display is provided as a touch display, a separate input may not be provided in the remote controller.

The indoor controller 10 may acquire an input (e.g., a user input). For example, the indoor controller 10 may acquire an operation mode selection input for selecting an operation mode and may acquire a temperature setting input for setting an indoor temperature. The indoor controller 10 may be a separate input device distinguishable from the remote controller. The indoor controller 10 may be provided with a simpler structure than the remote controller. Indoor temperature setting or current setting of the outdoor unit 20 may be simply input by the indoor controller 10.

The indoor controller 10 may include an operation mode input and an adjuster. The operation mode input and the adjuster may be respectively provided as rotatable dials. The operation mode input and the adjuster are not limited to dials and may be provided in various forms. The operation mode input and the adjuster may also include various buttons.

The operation mode input may be provided to select an operation mode of the air conditioner 1. The indoor controller 10 may transmit an electrical signal (operation mode selection signal) corresponding to the operation of the operation mode input to the main controller 2. For example, the operation mode of the air conditioner 1 may include a cooling operation mode, a heating operation mode, and an auto operation mode. The air conditioner 1 may operate in an operation mode selected according to the manipulation of the operation mode input. That is, the air conditioner 1 may perform cooling operation, heating operation, or auto operation. The user may manipulate the operation mode input to select power off, cooling operation, heating operation, or auto operation.

The elements of the air conditioner 1 are not limited to the above-described ones. In addition to the elements of the outdoor unit 20 described above, other elements may be added.

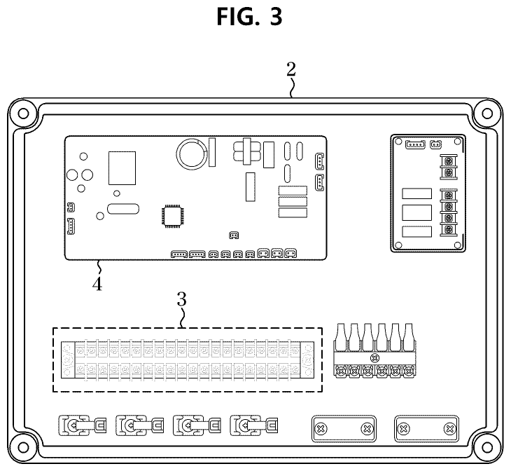

FIG. 3 is a diagram illustrating an example main controller according to various embodiments.

With reference to FIG. 3, the main controller 2 may include a main circuit board 4 and a plurality of contact terminals 3. The memory 112 and the processor 111 may be mounted on the main circuit board 4. The processor 111 may also be referred to as a “micom”. The communication circuitry 100 may communicate with external devices through terminal blocks for connection with other devices, in addition to the contact terminals 3.

The plurality of contact terminals 3 may be connected to the outdoor unit 20, the indoor unit 30, and the indoor controller 10. The contact terminals 3 include at least one of a F1 terminal, a F2 terminal, a TR terminal, a TEI terminal, a TEO terminal, a F3 terminal, a F4 terminal, a COM terminal, an AUT terminal, a HP terminal, a CO terminal, an AV1 terminal, or an AV2 terminal. The contact terminals 3 and each of the outdoor unit 20, the indoor unit 30, and the indoor controller 10 may be connected via electric wires and/or cables.

For example, the outdoor unit 20 may be connected to an F1 terminal and an F2 terminal (not shown) among the contact terminals 3. The main controller 2 may communicate with the outdoor unit 20 through the F1 terminal and F2 terminal. For example, a signal generated by the processor 111 of the main controller 2 may be transmitted to the outdoor unit 20 through the F1 and F2 terminals, and a signal generated by the outdoor unit 20 may be transmitted to the processor 111 through the F1 and F2 terminals.

The indoor unit 30 may be connected to a TR terminal, a TEI terminal, and a TEO terminal (not shown) among the contact terminals 3. As described above, the indoor unit 30 may include an indoor temperature sensor and an indoor heat exchanger temperature sensor. A signal generated by the indoor temperature sensor of the indoor unit 30 may be input to the processor 111 of the main controller 2 through the TR terminal. A signal generated by the indoor heat exchanger temperature sensor of the indoor unit 30 may be input to the processor 111 of the main controller 2 through the TEI terminal and the TEO terminal.

The remote controller may be connected to an F3 terminal and an F4 terminal (not shown) among the contact terminals 3. The main controller 2 may communicate with the remote controller through the F3 terminal and F4 terminal. For example, a signal generated by the processor 111 of the main controller 2 may be transmitted to the remote controller through the F3 terminal, and a signal generated by the remote controller may be transmitted to the processor 111 through the F4 terminal.

The indoor controller 10 may be connected to a COM terminal, an AUT terminal, an HP terminal, a CO terminal, an AV1 terminal, and an AV2 terminal (not shown) among the contact terminals 3. The COM terminal, the AUT terminal, the HP terminal, and the CO terminal may be connected to the operation mode input of the indoor controller 10. The COM terminal may refer to a common terminal, the AUT terminal may receive an auto operation signal, the HP terminal may receive a heating operation signal, and the CO terminal may receive a cooling operation signal. According to the operation of the operation mode input, a signal may be input to one of the AUT terminal, the HP terminal, or the CO terminal.

The AV1 terminal and the AV2 terminal may be connected to the adjuster of the indoor controller 10. The AV1 terminal may be referred to as a first contact terminal, and the AV2 terminal may be referred to as a second contact terminal. The voltage of the signal applied to the first contact terminal (AV1 terminal) may vary according to the operation of the adjuster. In other words, the voltage applied between the first contact terminal (AV1 terminal) and the second contact terminal (AV2 terminal) may vary depending on the operation of the adjuster. The main controller 2 may determine the target temperature for the indoor space or the maximum current applied to the outdoor unit 20 based on the voltage of the signal applied to the first contact terminal (AV1 terminal).

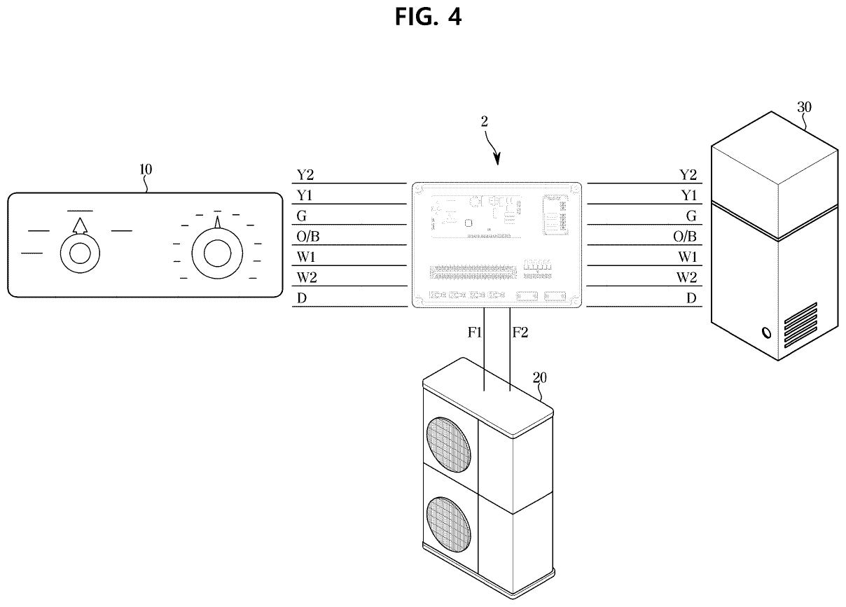

FIG. 4 is a diagram illustrating a connection between the main controller and components of the air conditioner in the air conditioner according to various embodiments.

With reference to FIG. 4, the contact signal line of the indoor controller 10 may be connected to the main controller 2. For example, a first compressor terminal Y1, a second compressor terminal Y2, a first auxiliary heat source terminal W1, a second auxiliary heat source terminal W2, a fan terminal G for controlling the indoor fan, a 4-way valve terminal O/B for controlling the 4-way valve, etc., which are extended from the indoor controller 10, may be connected to the main controller 2 instead of being directly connected to the indoor unit 30 or the outdoor unit 20.

In the main controller 2, the first signal received from the indoor controller 10 may be converted to generate a second signal, and the second signal may be transmitted to the outdoor unit 20. Also, the first signal may be delayed or blocked to finely control the operation of the indoor unit 30.

Accordingly, although in the related art, an outdoor unit 20 having a different communication method from that of the indoor controller 10 could not be installed, in the air conditioner 1 according to an embodiment, even if an outdoor unit 20 has a different communication method, the outdoor unit 20 with a different communication method may be used because the main controller 2 converts the signal to match the communication method. In addition, although in the related art, the air conditioner fan, auxiliary heat source, and other air conditioning devices could not be finely controlled due to the contact communication method, fine control may be possible based on the signal blocking or delay from the main controller 2.

For example, the indoor controller 10 and the indoor unit 30 may transmit and receive the first signal via a first communication method using a contact method, but may not support a second communication method using the RS 485 method. Additionally, the outdoor unit 20 may receive the second signal using the second communication method such as the RS 485 method, but may not support the first communication method using the contact method. Here, the expression “support a communication method” may refer, for example, to the device being equipped with a connection terminal and a signal processing circuit for communicating by the corresponding communication method, and that the device is capable of transmitting and receiving signals by the corresponding communication method.

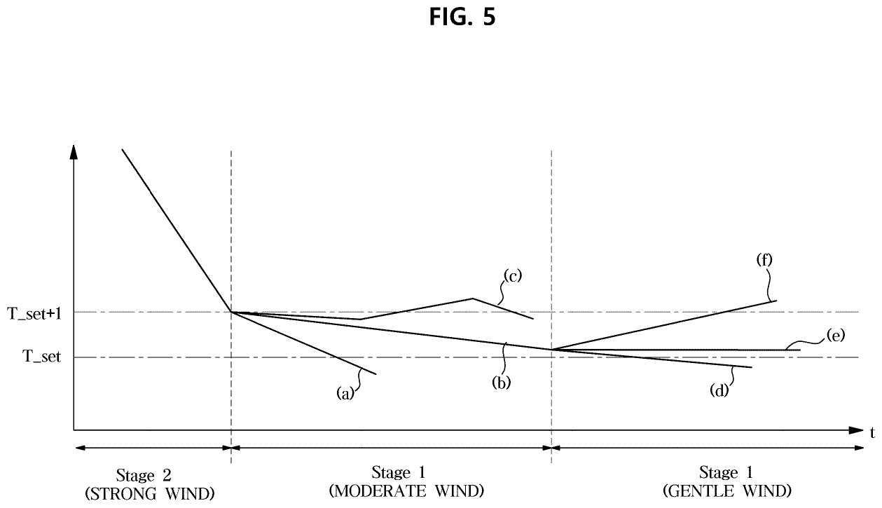

FIG. 5 is a graph illustrating an example process in which cooling is controlled by the main controller when the indoor controller is a 2-stage indoor controller according to various embodiments.

The 2-stage indoor controller 10 refers to an indoor controller 10 capable of determining the intensity of cooling or heating in addition to turning on/off the cooling or heating. In contrast, the 1-stage indoor controller 10 refers to an indoor controller 10 that is capable of controlling only the on/off of cooling or heating, and is therefore incapable of adjusting the intensity of cooling or heating.

For example, the 2-stage indoor controller 10 may receive, as input, a user command so that the user performs cooling, and at the same time, may receive, as input, a command to adjust the intensity of cooling to cooling with strong wind or cooling with moderate wind. In contrast, the 1-stage indoor controller 10 may receive, as input, only a user command so that the user performs cooling, and the intensity of cooling may be controlled by turning on or off the air conditioner 1.

With reference to FIG. 5, T_set on the vertical axis of the graph may refer, for example, to a target indoor temperature input by the user to the indoor controller 10, and T_set+1 may refer, for example, to a temperature of 1 degree higher than the target indoor temperature, and when the indoor temperature is T_set+1, the T set+1 is a boundary temperature at which the main controller 1 determines the cooling intensity. The boundary temperature has a different value depending on the indoor controller 10. The horizontal axis t of the graph indicates time, and it may refer, for example, to the time elapsing as the graph proceeds from left to right.

Describing from the left side of the horizontal axis of the graph, a user may input T_set into the indoor controller 10, and, for example, may input 20 degrees Celsius into the indoor controller 10. Accordingly, the indoor controller 10 may transmit a plurality of first signals for lowering the temperature to the main controller 2, and the main controller 2 may control the outdoor unit 20 and the indoor unit 30 to lower the indoor temperature.

In this case, the main controller 2 may determine whether to perform a 1-stage operation or a 2-stage operation based on the plurality of first signals received. For example, when performing cooling, the main controller 2 may operate in the 2-stage when the plurality of first signals received from the indoor controller 10 include both a signal of the first compressor terminal Y1 and a signal of the second compressor terminal Y2, and may operate in the 1-stage when the plurality of first signals received from the indoor controller 10 include the signal of the first compressor terminal Y1 but do not include the signal of the second compressor terminal Y2. FIG. 5 is described based on the type of the indoor controller 10 being the 2-stage type in the cooling operation.

Under the control of the main controller 2, the indoor temperature may decrease toward T_set, and may decrease to a temperature lower than T_set+1. When the indoor temperature decreases to a temperature lower than T_set+1, the indoor controller 10 may transmit a signal for decreasing the operation stage of the indoor unit 30 to the main controller 2. That is, when the indoor temperature decreases to a temperature lower than T_set+1, the indoor controller 10 may transmit a signal to the main controller 2 to decrease the operation stage of the indoor unit 30 so as to change to moderate wind that provides appropriate cooling, in order to prevent and/or reduce the indoor temperature from dropping below T_set due to cooling with strong wind.

Accordingly, the main controller 2 may change the operation stage of the indoor unit 30 from a third stage corresponding to strong wind to a second stage corresponding to moderate wind, and may turn off the indoor unit 30 based on the target indoor temperature being reached after the operation stage is decreased from the third stage to the second stage (a). That is, because the target indoor temperature desired by the user has been reached, the operation of the air conditioner 1 may be stopped for energy efficiency.

The main controller 2, based on the indoor unit 30 continuously operating the second stage for a reference time without being turned off after the operation stage is decreased from the third stage to the second stage, may decrease the wind volume level of the indoor unit 30 from the second stage to the first stage (b). For example, when the indoor temperature is not decreased to be equal to or less than the target indoor temperature, and the indoor unit 30 is not turned off, the operation stage may be changed from the second stage, corresponding to moderate wind, to the first stage, corresponding to gentle wind, for energy efficiency.

The main controller 2, based on the wind volume level of the indoor unit 30 being changed from the second stage to the third stage again within a reference time after the wind volume level of the indoor unit 30 is decreased from the third stage to the second stage, may decrease the target pressure of the compressor in the second stage compared to before (c). For example, when the indoor temperature is decreased to be equal to or less than T_set+1, and then increased to be T_set+1 or higher due to a specific cause, so that the strong wind is entered, the cooling performance may be increased by reducing the target pressure of the compressor when re-entering the moderate wind, so that escape into the strong wind does not occur again.

When the wind volume level of the indoor unit 30 is decreased from the second stage to the first stage (b), and the indoor temperature is then decreased to be equal to or less than T_set by the operation of the first stage, which corresponds to gentle wind, the main controller 2 may turn off the indoor unit 30 (d). For example, because the target indoor temperature desired by the user has been reached, the operation of the air conditioner 1 may be stopped for energy efficiency.

When the wind volume level of the indoor unit 30 is decreased from the second stage to the first stage (b), and the indoor temperature then remains between T_set+1 and T_set, the main controller 2 may control the indoor unit 30 and the outdoor unit 20 to continue operating in the first stage, which corresponds to gentle wind (e).

When the wind volume level of the indoor unit 30 is decreased from the second stage to the first stage (b), and the indoor temperature is then increased to T_set+1 or higher, the main controller 2 may control the indoor unit 30 and the outdoor unit 20 to escape from the gentle wind to the strong wind and continue operating in the strong wind (f).

As described above, the air conditioner 1 according to an embodiment may control the indoor temperature by taking into account the indoor temperature and the information of the outdoor unit 20, thereby improving energy efficiency and user comfort, unlike the related art that only performs on/off control.

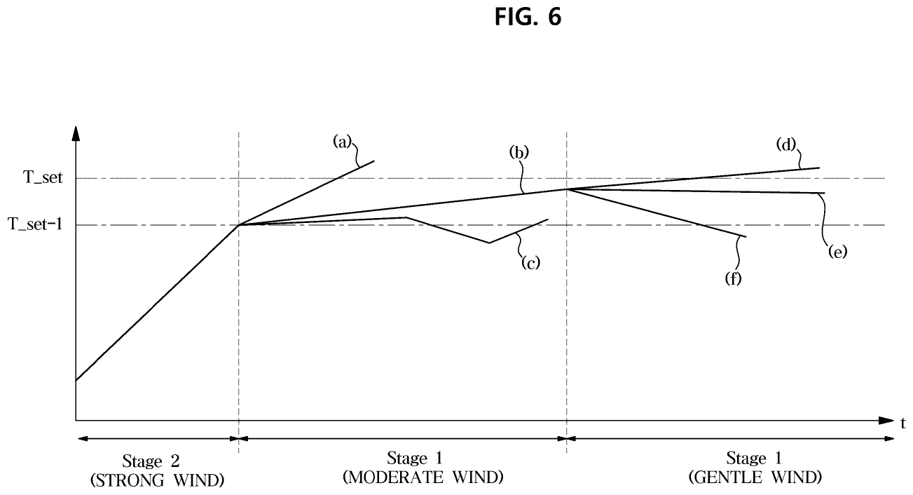

FIG. 6 is a graph illustrating an example process in which heating is controlled by the main controller 2 when the indoor controller 10 is a 2-stage indoor controller 10, according to various embodiments.

Similar to FIG. 5, T_set on the vertical axis of the graph indicates a target indoor temperature input by the user into the indoor controller 10, and T_set−1 is a boundary temperature for determining heating intensity, and may have different values depending on the indoor controller 10. The horizontal axis t of the graph indicates time, and it may refer, for example, to time elapsing as the graph proceeds from left to right.

Describing from the left side of the horizontal axis of the graph, a user may input T_set into the indoor controller 10, and, for example, may input 28 degrees Celsius into the indoor controller 10. Accordingly, the indoor controller 10 may transmit a plurality of first signals for raising the temperature to the main controller 2, and the main controller 2 may control the outdoor unit 20 and the indoor unit 30 to raise the indoor temperature.

In this case, the main controller 2 may determine whether the indoor controller 10 performs a 1-stage operation or a 2-stage operation based on the plurality of first signals received. For example, when performing heating, the main controller 2 may operate in the 2-stage when the plurality of first signals received from the indoor controller 10 include both a signal of the first compressor terminal Y1 and a signal of the second compressor terminal Y2, and may operate in the 1-stage when the plurality of first signals received from the indoor controller 10 include the signal of the first compressor terminal Y1 but do not include the signal of the second compressor terminal Y2. FIG. 6 is described on the premise that the type of the indoor controller 10 is the 2-stage type in the heating operation.

Under the control of the main controller 2, the indoor temperature may increase toward T_set, and may increase to a temperature higher than T_set−1. When the indoor temperature increases to a temperature higher than T_set−1, the indoor controller 10 may transmit a signal for decreasing the operation stage of the indoor unit 30 to the main controller 2. That is, when the indoor temperature increases to a temperature higher than T_set−1, the indoor controller 10 may transmit a signal to the main controller 2 to decrease the operation stage of the indoor unit 30 so as to change to moderate wind that provides appropriate heating, in order to prevent and/or reduce the indoor temperature from rising above T_set due to cooling with strong wind.

Accordingly, the main controller 2 may change the operation stage of the indoor unit 30 from a third stage corresponding to strong wind to a second stage corresponding to moderate wind, and may turn off the indoor unit 30 based on the target indoor temperature being reached after the operation stage is decreased from the third stage to the second stage (a). That is, because the target indoor temperature desired by the user has been reached, the operation of the air conditioner 1 may be stopped for energy efficiency.

The main controller 2, based on the indoor unit 30 continuously operating the second stage for a reference time without being turned off after the operation stage is decreased from the third stage to the second stage, may decrease the wind volume level of the indoor unit 30 from the second stage to the first stage (b). For example, when the indoor temperature is not increased to be equal to or greater than the target indoor temperature, and the indoor unit 30 is not turned off, the operation stage may be changed from the second stage, corresponding to moderate wind, to the first stage, corresponding to gentle wind, for energy efficiency.

The main controller 2, based on the wind volume level of the indoor unit 30 being changed from the second stage to the third stage again within a reference time after the wind volume level of the indoor unit 30 is decreased from the third stage to the second stage, may increase the target pressure of the compressor in the second stage (c). For example, when the indoor temperature is increased to be equal to or greater than T_set−1, and then decreased to be T_set−1 or lower due to a specific cause, so that the strong wind is entered, the heating performance may be increased by increasing the target pressure of the compressor when re-entering the moderate wind, so that escape into the strong wind does not occur again.

When the wind volume level of the indoor unit 30 is decreased from the second stage to the first stage (b), and the indoor temperature is then increased to be equal to or greater than T_set by the operation of the first stage, which corresponds to gentle wind, the main controller 2 may turn off the indoor unit 30 (d). For example, because the target indoor temperature desired by the user has been reached, the operation of the air conditioner 1 may be stopped for energy efficiency.

When the wind volume level of the indoor unit 30 is decreased from the second stage to the first stage (b), and the indoor temperature then remains between T_set and T_set−1 the main controller 2 may control the indoor unit 30 and the outdoor unit 20 to continue operating in the first stage, which corresponds to gentle wind (e).

When the wind volume level of the indoor unit 30 is decreased from the second stage to the first stage (b), and the indoor temperature is then decreased to T_set−1 or lower, the main controller 2 may control the indoor unit 30 and the outdoor unit 20 to escape from the gentle wind to the strong wind and continue operating in the strong wind (f).

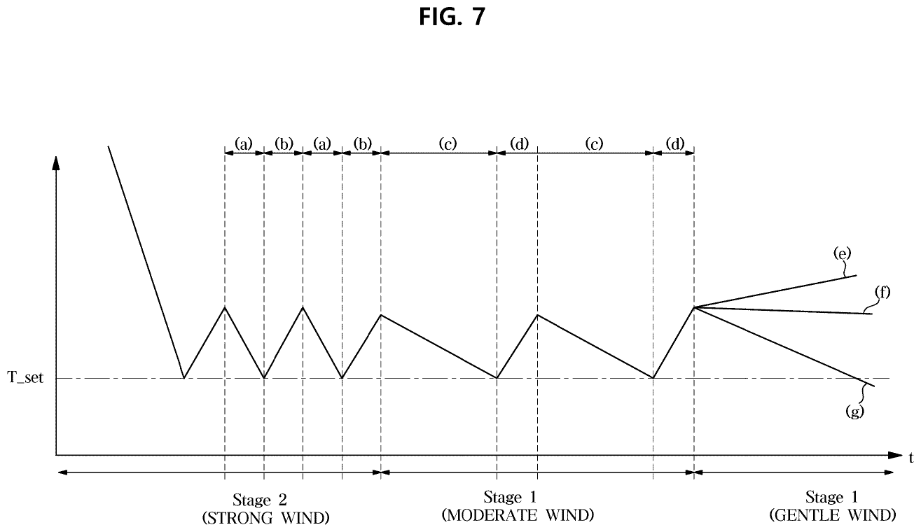

FIG. 7 is a graph illustrating an example process in which cooling is controlled by the main controller 2 when the indoor controller 10 is a 1-stage indoor controller 10, according to various embodiments.

With reference to FIG. 7, T_set on the vertical axis of the graph indicates a target indoor temperature input by the user to the indoor controller 10, and when the target indoor temperature is input, the main controller 2 may control the indoor unit 30 to operate in the strong wind in order to lower the indoor temperature. The horizontal axis t of the graph indicates time, and may refer, for example to time elapsing as the graph proceeds from left to right.

Describing from the left side of the horizontal axis of the graph, a user may input T_set into the indoor controller 10, and, for example, may input 20 degrees Celsius into the indoor controller 10. Accordingly, the indoor controller 10 may transmit a plurality of first signals for lowering the temperature to the main controller 2, and the main controller 2 may control the outdoor unit 20 and the indoor unit 30 to lower the indoor temperature.

In this case, as described above, the main controller 2 determines whether the indoor controller 10 performs a 1-stage operation or a 2-stage operation, based on the plurality of first signals received. In FIG. 7, the description is made based on the type of the indoor controller 10 being determined to be a 1-stage type.

According to the control of the main controller 2, the indoor temperature may decrease toward T_set and may reach T_set. When the indoor temperature reaches T_set, the main controller 2 may decrease the wind volume level of the indoor unit 30 from the third stage to the second stage, based on the combination of the number of times the off signal is output and the off signal output time of the indoor controller 10.

For example, after the indoor temperature reaches T_set, when the number of times the off signal is output by the indoor controller 10 is equal to or greater than a reference number of times, and the off signal output time is equal to or less than a reference time, the main controller 2 may determine that the cooling capacity is sufficient and may decrease the wind volume level of the indoor unit 30 from the third stage to the second stage.

For example, when the main controller 2 controls the indoor unit 30 in the third stage, which is the strong wind, and the indoor temperature reaches T_set, the main controller 2 may determine whether the number of times the off signal is output and the off signal output time of the indoor controller 10 satisfy a preset pattern.

For example, in FIG. 7, after the indoor temperature reaches T_set, the main controller 2 operated the cooling operation again for 30 minutes or less (a) due to the increase in indoor temperature, and the cooling off signal was received for 20 minutes or less (b) to stop the cooling. Subsequently, the indoor temperature rises again, the cooling operation is performed for 30 minutes or less (a), and the cooling off signal is received for 20 minutes or less (b) to stop the cooling. As such, when a pattern in which the cooling operation and stopping are repeated occurs two or more times, the main controller 2 may determine that the cooling capacity is sufficient and may decrease the wind volume level of the indoor unit 30 from the third stage to the second stage for energy efficiency.

The main controller 2 may turn off the indoor unit 30 based on the indoor temperature reaching the target indoor temperature, after the wind volume level of the indoor unit 30 is decreased from the third stage to the second stage.

When, after the wind volume level of the indoor unit 30 is decreased from the third stage to the second stage, the number of times the off signal is output by the indoor controller 10 is equal to or greater than a reference number of times, and the off signal output time is equal to or less than a reference time, the main controller 2 may determine that the cooling capacity at the second stage is also sufficient and may decrease the wind volume level of the indoor unit 30 from the second stage to the first stage.

Based on, after the wind volume level of the indoor unit 30 is decreased from the third stage to the second stage, the indoor unit 30 continuously operating at the second stage without being turned off for the reference time or longer, and the indoor unit 30 being turned off for the reference time or longer, the main controller 2 may increase the wind volume level of the indoor unit 30 from the second stage to the third stage, and may perform room temperature control based on the load of the outdoor unit 20.

When the main controller 2 controls the indoor unit 30 in the second stage, which is the moderate wind, and the indoor temperature reaches T_set, the main controller 2 may determine whether the number of times the off signal is output and the off signal output time of the indoor controller 10 satisfy a preset pattern.

For example, in FIG. 7, after the indoor temperature reaches T_set, the main controller 2 operated the cooling operation again using the moderate wind for 40 minutes or less (c) due to the increase in indoor temperature, and the cooling off signal was received for 20 minutes or less (d), enabling the cooling to be stopped. Subsequently, the indoor temperature rises again, the cooling operation is performed for 40 minutes or less (c), and the cooling off signal is received for 20 minutes or less (d), enabling the cooling to be stopped. As such, when a pattern in which the cooling operation and stopping are repeated occurs two or more times, the main controller 2 may determine that the cooling capacity is sufficient and may decrease the wind volume level of the indoor unit 30 from the second stage to the first stage for energy efficiency.

When the wind volume level of the indoor unit 30 is decreased from the second stage to the first stage, and the indoor temperature is then decreased to be equal to or less than T_set by the operation of the first stage, which corresponds to gentle wind, the main controller 2 may turn off the indoor unit 30 (g). That is, because the target indoor temperature desired by the user has been reached, the operation of the air conditioner 1 may be stopped for energy efficiency.

When the wind volume level of the indoor unit 30 is decreased from the second stage to the first stage, and the indoor temperature then maintains a temperature slightly higher than T_set (e.g., within a difference of 2 degrees), the main controller 2 may control the indoor unit 30 and the outdoor unit 20 to sequentially escape from the gentle wind, which corresponds to the first stage, to moderate wind and strong wind, based on continuous operation time, so that cooling performance may be increased (e, f).

When the wind volume level of the indoor unit 30 is decreased from the second stage to the first stage, and the indoor temperature then decreases to be equal to or less than T_set, the main controller 2 may control the indoor unit 30 and the outdoor unit 20 to continuously operate with the gentle wind, based on continuous operation time (g).

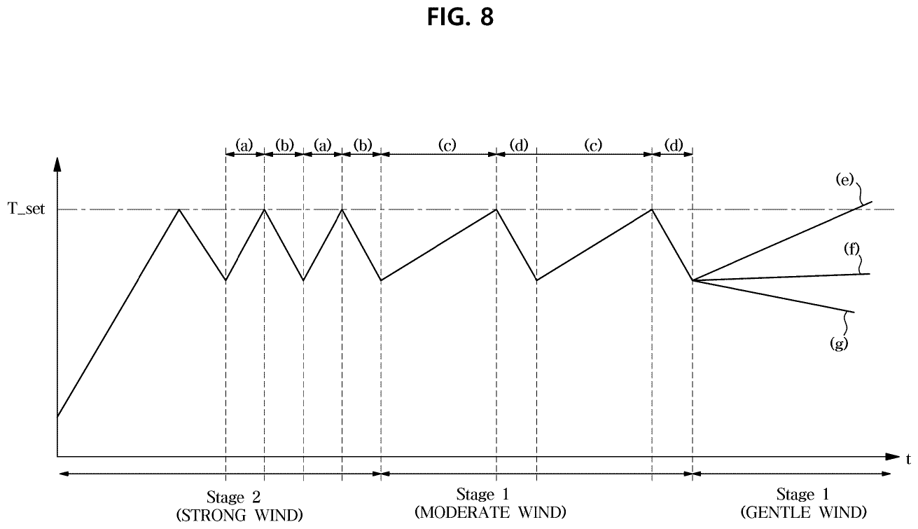

FIG. 8 is a graph illustrating an example process in which heating is controlled by the main controller 2 when the indoor controller 10 is a 1-stage indoor controller 10, according to various embodiments.

With reference to FIG. 8, T_set on the vertical axis of the graph indicates a target indoor temperature input by the user to the indoor controller 10, and when the target indoor temperature is input, the main controller 2 may control the indoor unit 30 to operate in the strong wind in order to raise the indoor temperature. The horizontal axis t of the graph indicates time, and may refer, for example, to time elapsing as the graph proceeds from left to right.

Describing from the left side of the horizontal axis of the graph, a user may input T_set into the indoor controller 10, and, for example, may input 28 degrees Celsius into the indoor controller 10. Accordingly, the indoor controller 10 may transmit a plurality of first signals for raising the temperature to the main controller 2, and the main controller 2 may control the outdoor unit 20 and the indoor unit 30 to raise the indoor temperature.

In this case, as described above, the main controller 2 may determine whether the indoor controller 10 performs a 1-stage operation or a 2-stage operation, based on the plurality of first signals received. In FIG. 8, the description is made based on the type of the indoor controller 10 being determined to be a 1-stage type.

According to the control of the main controller 2, the indoor temperature may increase toward T_set and may reach T_set. When the indoor temperature reaches T_set, the main controller 2 may decrease the wind volume level of the indoor unit 30 from the third stage to the second stage, based on the combination of the number of times the off signal is output and the off signal output time of the indoor controller 10.

For example, after the indoor temperature reaches T_set, when the number of times the off signal is output by the indoor controller 10 is equal to or greater than a reference number of times, and the off signal output time is equal to or less than a reference time, the main controller 2 may determine that the heating capacity is sufficient and may decrease the wind volume level of the indoor unit 30 from the third stage to the second stage.

For example, when the main controller 2 controls the indoor unit 30 in the third stage, which is the strong wind, and the indoor temperature reaches T_set, the main controller 2 may determine whether the number of times the off signal is output and the off signal output time of the indoor controller 10 satisfy a preset pattern.

For example, in FIG. 8, after the indoor temperature reaches T_set, the main controller 2 operated the heating operation again for 30 minutes or less (a) due to the decrease in indoor temperature, and the heating off signal was received for 20 minutes or less (b), enabling the heating to be stopped. Subsequently, the indoor temperature decreases again, the heating operation is performed for 30 minutes or less (a), and the heating off signal is received for 20 minutes or less (b) to stop the heating. As such, when a pattern in which the heating operation and stopping are repeated occurs two or more times, the main controller 2 may determine that the heating capacity is sufficient and may decrease the wind volume level of the indoor unit 30 from the third stage to the second stage for energy efficiency.

The main controller 2 may turn off the indoor unit 30 based on the indoor temperature reaching the target indoor temperature, after the wind volume level of the indoor unit 30 is decreased from the third stage to the second stage.

When, after the wind volume level of the indoor unit 30 is decreased from the third stage to the second stage, the number of times the off signal is output by the indoor controller 10 is equal to or greater than a reference number of times, and the off signal output time is equal to or less than a reference time, the main controller 2 may determine that the cooling capacity at the second stage is also sufficient and may decrease the wind volume level of the indoor unit 30 from the second stage to the first stage.

Based on, after the wind volume level of the indoor unit 30 is decreased from the third stage to the second stage, the indoor unit 30 continuously operating at the second stage without being turned off for a reference time or longer, and the indoor unit 30 being turned off for the reference time or longer, the main controller 2 may increase the wind volume level of the indoor unit 30 from the second stage to the third stage, and may perform room temperature control based on the load of the outdoor unit 20.

When the main controller 2 controls the indoor unit 30 in the second stage, which is the moderate wind, and the indoor temperature reaches T_set, the main controller 2 may determine whether the number of times the off signal is output and the off signal output time of the indoor controller 10 satisfy a preset pattern.

For example, in FIG. 8, after the indoor temperature reaches T_set, the main controller 2 operated the heating operation again using the moderate wind for 40 minutes or less (c) due to the decrease in indoor temperature, and the heating off signal was received for 20 minutes or less (d), enabling the heating to be stopped. Subsequently, the indoor temperature rises again, the heating operation is performed for 40 minutes or less (c), and the heating off signal is received for 20 minutes or less (d), enabling the heating to be stopped. As such, when a pattern in which the heating operation and stopping are repeated occurs two or more times, the main controller 2 may determine that the heating capacity is sufficient and may decrease the wind volume level of the indoor unit 30 from the second stage to the first stage for energy efficiency.

When the wind volume level of the indoor unit 30 is decreased from the second stage to the first stage, and the indoor temperature is then increased to be equal to or greater than T_set by the operation of the first stage, which corresponds to gentle wind, the main controller 2 may turn off the indoor unit 30 (e). That is, because the target indoor temperature desired by the user has been reached, the operation of the air conditioner 1 may be stopped for energy efficiency.

When the wind volume level of the indoor unit 30 is decreased from the second stage to the first stage, and the indoor temperature then maintains a temperature slightly lower than T_set (e.g., within a difference of 2 degrees), the main controller 2 may control the indoor unit 30 and the outdoor unit 20 to sequentially escape from the gentle wind, which corresponds to the first stage, to moderate wind and strong wind, based on continuous operation time, so that heating performance may be increased (f, g).

When the wind volume level of the indoor unit 30 is decreased from the second stage to the first stage, and the indoor temperature then increases to be equal to or greater than T_set, the main controller 2 may control the indoor unit 30 and the outdoor unit 20 to continuously operate with the gentle wind, based on continuous operation time (e).

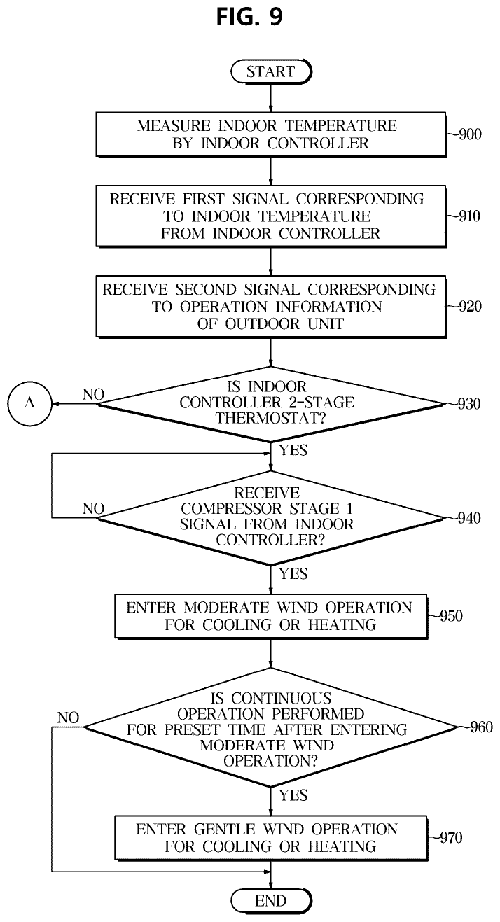

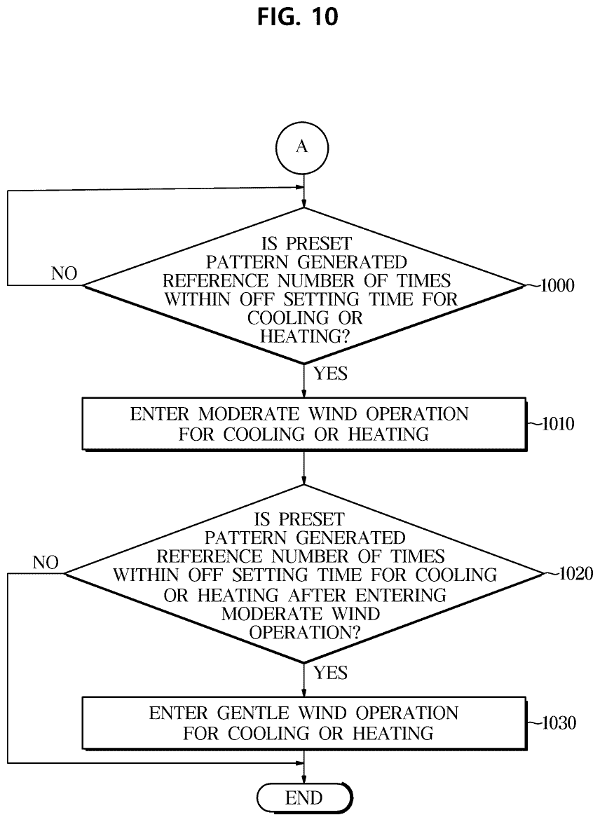

FIG. 9 is a flowchart illustrating an example method of controlling the air conditioner 1 according to various embodiments, and FIG. 10 is a flowchart relating to the example method of controlling the air conditioner 1, following FIG. 9 according to various embodiments.

With reference to FIG. 9, the indoor controller 10 may measure an indoor temperature for room temperature control (900), and may generate a first signal corresponding to the indoor temperature.

The main controller 2 may receive a plurality of first signals corresponding to the indoor temperature from the indoor controller 10 (910), and may receive a second signal corresponding to operation information of the outdoor unit 20 from the outdoor unit 20 (920).

The main controller 2 may determine whether the indoor controller 10 performs 1-stage operation or 2-stage operation, based on whether a signal of the second compressor terminal Y2 is included in the plurality of first signals received from the indoor controller 10 (930).

When it is determined that the indoor controller 10 is a 2-stage thermostat (YES in 930), it may be determined whether a compressor stage 1 signal is received from the indoor controller 10 (940). In this case, the compressor stage 1 signal corresponds to a stage-down signal for decreasing the wind volume level of the indoor unit 30 from the strong wind to the moderate wind.

When the main controller 2 receives the compressor stage 1 signal from the indoor controller 10 (YES in 940), the main controller 2 may change the operation from strong wind operation to moderate wind operation for cooling or heating (950). The main controller 2 may determine whether continuous operation in the moderate wind is performed for a preset time after entry into the moderate wind operation (960), and when it is determined that the moderate wind operation has been continuously performed for the preset time (YES in 960), the main controller 2 may allow the operation to enter the gentle wind operation (970) from the moderate wind operation for cooling or heating. Accordingly, the air conditioner 1 according to an embodiment may maximize and/or improve energy efficiency because the wind volume level may be adjusted without stopping the air conditioner 1.

With reference to FIG. 10, when the indoor controller 10 is determined to be a 1-stage thermostat (No in 930), it may be determined whether a preset pattern is generated at least a reference number of times within an off setting time for cooling or heating (1000). The preset pattern refers to a pattern formed based on the number of times the off signal is output and the off signal output time for cooling or heating output from the indoor controller 10, as described in FIG. 7.

When the main controller 2 determines that the preset pattern is generated at least the reference number of times within the off setting time for cooling or heating (Yes in 1000), the main controller 2 may switch the operation from the strong wind operation to the moderate wind operation for cooling or heating (1010).

The main controller 2 may determine whether the preset pattern is generated at least the reference number of times within the off setting time for cooling or heating after entering the moderate wind operation (1020). The main controller 2, when it is determined that the preset pattern is generated at least the reference number of times within the off setting time for cooling or heating after entering the moderate wind operation (YES in 1020), may switch the operation from the moderate wind operation to the gentle wind operation for cooling or heating (1030).

As described above, in the related art, the indoor unit 30 and the outdoor unit 20 were turned on or off to control the room temperature only through the on/off signal of the indoor fan and the on/off signal of the compressor output from the thermostat, whereas, according to the present disclosure, the communication between the outdoor unit 20 and the main controller 2 is implemented, and the on/off signal of the indoor controller 10 and the information of the outdoor unit 20 may be integrated, and accordingly, the effect of implementing more stable room temperature control may be achieved. In addition, as the outdoor unit 20 actively intervenes in the target pressure adjustment and wind volume level control of the indoor unit 30 when approaching the target set temperature, the frequency of the on/off signal of the indoor controller 10 may be reduced and the fluctuation range of the room temperature may be minimized and/or reduced, thereby achieving the effect of improving energy efficiency.

An air conditioner 1 according to an embodiment includes: an indoor controller 10 configured to receive, as input, an operation command from a user and to generate a plurality of first signals corresponding to the operation command; a main controller 2 connected to the indoor controller, configured to receive the plurality of first signals and to combine and convert the plurality of first signals into a single second signal; an outdoor unit 20 connected to the main controller 2, configured to operate based on the single second communication signal received from the main controller 2, and to generate a third signal corresponding to an operating state of the outdoor unit 20; and an indoor unit 30 connected to the main controller 2, in which a fan of the indoor unit 30 is provided, in which the main controller 2 determines a type of the indoor controller 10 based on the plurality of first signals, and controls an operation of the indoor unit 30 based on the type of the indoor controller 10 and a temperature setting signal among the plurality of first signals.

The type of the indoor controller 10 may include a 1-stage type and a 2-stage type.

The main controller 2, based on the type of the indoor controller 10 being determined to be the 2-stage type, may decrease a wind volume level of the indoor unit 30 from a third stage to a second stage according to a stage decrease command received from the indoor controller 10.

The main controller 2 may turn off the indoor unit 30 based on a target indoor temperature corresponding to the operation command of the user being reached after the wind volume level of the indoor unit 30 is decreased from the third stage to the second stage.

The main controller 2, based on the indoor unit 30 continuously operating at the second stage for a reference time without being turned off after the wind volume level of the indoor unit 30 is decreased from the third stage to the second stage, may decrease the wind volume level of the indoor unit 30 from the second stage to a first stage.

The main controller 2, based on the wind volume level of the indoor unit 30 being changed from the second stage to the third stage within a reference time after the wind volume level of the indoor unit 30 is decreased from the third stage to the second stage, may increase a compressor pressure at the second stage.

The main controller 2, based on the type of the indoor controller 10 being determined to be a 1-stage type, may decrease the wind volume level of the indoor unit 30 from the third stage to the second stage according to a combination of the number of times an off signal is output and an off signal output time of the indoor controller 10.

The main controller 2 may turn off the indoor unit 30 based on a target indoor temperature corresponding to the operation command of the user being reached after the wind volume level of the indoor unit 30 is decreased from the third stage to the second stage.

The main controller 2, based on the indoor unit 30 continuously operating at the second stage for a reference time without being turned off after the wind volume level of the indoor unit 30 is decreased from the third stage to the second stage, may decrease the wind volume level of the indoor unit 30 from the second stage to a first stage.

The main controller 2, based on a frequency of the compressor increasing reference number of times or more in a reference cycle after the wind volume level of the indoor unit 30 is decreased from the third stage to the second stage, may increase the wind volume level of the indoor unit 30 from the second stage to the third stage.

A control method of an air conditioner 1 according to an embodiment includes: receiving, by an indoor controller 10, as input, an operation command from a user and generating a plurality of first signals corresponding to the operation command;

receiving, by a main controller 2 being connected to the indoor controller, the plurality of first signals, combining the plurality of first signals, and converting the combined signals into a single second signal; generating, by an outdoor unit 20 being connected to the main controller 2 and operating based on the single second communication signal received from the main controller 2, a third signal corresponding to an operation state of the outdoor unit 20; and determining, by the main controller 2, a type of the indoor controller 10 based on the plurality of first signals, and controlling an operation of the indoor unit 30 based on the type of the indoor controller 10 and a temperature setting signal among the plurality of first signals.

The type of the indoor controller 10 may include a 1-stage type and a 2-stage type.

The control method of the air conditioner 1 according to an embodiment may further include: decreasing the wind volume level of the indoor unit 30 from a third stage to a second stage, according to a command to decrease a stage in the indoor controller 10, based on the type of the indoor controller 10 being determined to be a 2-stage type.

The control method of the air conditioner 1 according to an embodiment may further include: turning off the indoor unit 30 based on a target indoor temperature corresponding to the operation command of the user being reached after the wind volume level of the indoor unit 30 is decreased from the third stage to the second stage.

The control method of the air conditioner 1 according to an embodiment may further include: decreasing the wind volume level of the indoor unit 30 from the second stage to a first stage, based on the indoor unit 30 continuously operating at the second stage for a reference time without being turned off after the wind volume level of the indoor unit 30 is decreased from the third stage to the second stage.

The control method of the air conditioner 1 according to an embodiment may further include: increasing a compressor pressure at the second stage based the wind volume level of the indoor unit 30 being changed from the second stage to the third stage within a reference time after the wind volume level of the indoor unit 30 is decreased from the third stage to the second stage.

The control method of the air conditioner 1 according to an embodiment may further include: decreasing the wind volume level of the indoor unit 30 from the third stage to the second stage according to a combination of the number of times an off signal is output and an off signal output time of the indoor controller 10, based on the type of the indoor controller 10 being determined to be the 1-stage type.

The control method of the air conditioner 1 according to an embodiment may further include: turning off the indoor unit 30 based on a target indoor temperature corresponding to the operation command of the user being reached after the wind volume level of the indoor unit 30 is decreased from the third stage to the second stage.

The control method of the air conditioner 1 according to an embodiment may further include: decreasing the wind volume level of the indoor unit 30 from the second stage to a first stage, based on the indoor unit 30 continuously operating at the second stage for a reference time without being turned off after the wind volume level of the indoor unit 30 is decreased from the third stage to the second stage.

The control method of the air conditioner 1 according to an embodiment may further include: increasing the wind volume level of the indoor unit 30 from the second stage to the third stage, based on a frequency of the compressor increasing reference number of times or more in a reference cycle after the wind volume level of the indoor unit 30 is decreased from the third stage to the second stage.

The disclosed embodiments may be implemented in the form of a storage medium that stores computer-executable instructions. The instruction may be stored in the form of a program code. When the instruction is executed by the processor 111, a program module may be generated, and operations of the disclosed embodiments may be performed.

The machine-readable storage medium may be provided in the form of a non-transitory storage medium. The “non-transitory storage medium” refers to a tangible device that may not include a signal (e.g., electromagnetic waves), and this term does not distinguish between cases where data is stored semi-permanently on the storage medium or temporarily stored. For example, a “non-transitory storage medium” may include a buffer where data is temporarily stored.

The method according to various embodiments disclosed in the present disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PLAYSTORE™), or between two user devices (e.g., smart phones) directly. In case of online distribution, at least a portion of the computer program product (e.g., a downloadable app) may be at least temporarily stored or temporarily generated on a machine-readable storage medium, such as the memory 112 of the manufacturer's server, the application store's server, or a relay server.

As described above, various example embodiments have been described with reference to the accompanying drawings. A person skilled in the art may understand that the present disclosure may be carried out in other forms different from those disclosed in various example embodiments without changing the technical spirit or the essential features of the present disclosure. The disclosed embodiments are illustrative and should not be interpreted as being restrictive.

In other words, while the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An air conditioner, comprising:
an indoor controller, comprising circuitry, configured to receive, as input, an operation command and to generate a plurality of first signals based on the operation command;
a main controller, comprising circuitry, connected to the indoor controller, configured to receive the plurality of first signals and to combine and convert the plurality of first signals into a single second signal;
an outdoor unit connected to the main controller, configured to operate based on the single second communication signal received from the main controller, and to generate a third signal based on an operating state of the outdoor unit; and
an indoor unit, connected to the main controller, and in which a fan of the indoor unit is provided, and
wherein the main controller is configured to determine a type of the indoor controller based on the plurality of first signals, and to control an operation of the indoor unit based on the type of the indoor controller and a temperature setting signal among the plurality of first signals.

2. The air conditioner of claim 1, wherein:
the type of the indoor controller includes a 1-stage type and a 2-stage type.

3. The air conditioner of claim 1, wherein:
the main controller, based on the type of the indoor controller being determined to be a 2-stage type, is configured to decrease a wind volume level of the indoor unit from a third stage to a second stage according to a stage decrease command received from the indoor controller.

4. The air conditioner of claim 3, wherein:
the main controller is configured to turn off the indoor unit based on a target indoor temperature corresponding to the operation command being reached after the wind volume level of the indoor unit is decreased from the third stage to the second stage.

5. The air conditioner of claim 3, wherein:
the main controller, based on the indoor unit continuously operating at the second stage for a reference time without being turned off after the wind volume level of the indoor unit is decreased from the third stage to the second stage, is configured to decrease the wind volume level of the indoor unit from the second stage to a first stage.

6. The air conditioner of claim 3, wherein:
the main controller, based on the wind volume level of the indoor unit being changed from the second stage to the third stage within a reference time after the wind volume level of the indoor unit is decreased from the third stage to the second stage, is configured to increase a compressor pressure at the second stage.

7. The air conditioner of claim 1, wherein:
the main controller, based on the type of the indoor controller being determined to be a 1-stage type, is configured to decrease a wind volume level of the indoor unit from a third stage to a second stage according to a combination of the number of times an off signal is output and an off signal output time of the indoor controller.

8. The air conditioner of claim 7, wherein:
the main controller is configured to turn off the indoor unit based on a target indoor temperature corresponding to the operation command being reached after the wind volume level of the indoor unit is decreased from the third stage to the second stage.

9. The air conditioner of claim 7, wherein:
the main controller, based on the indoor unit continuously operating at the second stage for a reference time without being turned off after the wind volume level of the indoor unit is decreased from the third stage to the second stage, is configured to decrease the wind volume level of the indoor unit from the second stage to the first stage.

10. The air conditioner of claim 7, wherein:
the main controller, based on a frequency of a compressor having increased at least a reference number of times in a reference cycle after the wind volume level of the indoor unit is decreased from the third stage to the second stage, is configured to increase the wind volume level of the indoor unit from the second stage to the third stage.

11. A method of controlling an air conditioner, comprising:
receiving, by an indoor controller, as input, an operation command and generating a plurality of first signals corresponding to the operation command;
receiving, by a main controller being connected to the indoor controller, the plurality of first signals, and combining the plurality of first signals to convert the combined plurality of first signals into a single second signal;
generating, by an outdoor unit being connected to the main controller and operating based on the single second signal received from the main controller, a third signal corresponding to an operation state of the outdoor unit; and
determining, by the main controller, a type of the indoor controller based on the plurality of first signals, and controlling an operation of the indoor unit based on the type of the indoor controller and a temperature setting signal among the plurality of first signals.

12. The method of claim 11, wherein:
the type of the indoor controller includes a 1-stage type and a 2-stage type.

13. The method of claim 11, further comprising:
decreasing a wind volume level of the indoor unit from a third stage to a second stage, according to a command to decrease a stage in the indoor controller, based on the type of the indoor controller being determined to be a 2-stage type.

14. The method of claim 13, further comprising:
turning off the indoor unit based on a target indoor temperature corresponding to the operation command being reached after the wind volume level of the indoor unit is decreased from the third stage to the second stage.

15. The method of claim 13, further comprising:
decreasing the wind volume level of the indoor unit from the second stage to a first stage, based on the indoor unit continuously operating at the second stage for a reference time without being turned off after the wind volume level of the indoor unit is decreased from the third stage to the second stage.
